(19) United States
(12) Patent Application Publication
(10) Pub. No.: US 2021/0354189 A1
(43) Pub. Date: Nov. 18, 2021

(54) Stamping Strip Manufacturing System

(71) Applicants: Tyco Electronics (Shanghai) Co. Ltd., Shanghai (CN); TE Connectivity Services GmbH, Schaffhausen (CH); TE Connectivity Germany GmbH, Bensheim (DE)

(72) Inventors: Yingcong Deng, Shanghai (CN); Dandan Zhang, Shanghai (CN); Lvhai Hu, Shanghai (CN); Fengchun Xie, Shanghai (CN); Roberto Francisco-Yi Lu, Bellevue, WA (US); Josef Sinder, Woert (DE); Zongjie Tao, Shanghai (CN); Xiaochen Yu, Shanghai (CN); Swapnilsinh Solanki, Middletown, PA (US); Jiankun Zhou, Middletown, PA (US); Tim Darr, Middletown, PA (US)

(73) Assignees: Tyco Electronics (Shanghai) Co. Ltd., Shanghai (CN); TE Connectivity Services GmbH, Schaffhausen (CH); TE Connectivity Germany GmbH, Bensheim (DE)

(21) Appl. No.: 17/320,445

(22) Filed: May 14, 2021

(30) Foreign Application Priority Data
May 14, 2020 (CN) 202010407391.4

(51) Int. Cl. B21D 43/10; B21D 43/28; B23K 37/04; B21D 43/20; B65G 47/90

(52) U.S. Cl. CPC B21D 43/10; B21D 43/285; B23K 2101/36; B21D 43/20; B65G 47/90; B23K 37/04

(57) ABSTRACT

A stamping strip manufacturing system comprises a stamping machine forming terminals in a strip by stamping, a supply reel around which the strip to be stamped is wound for supplying the strip to be stamped to the stamping machine, and a recovery reel around which the stamped strip is wound for recovering the stamped strip. The system further includes an autonomous mobile robot on which a cutting tool and a welding tool are mounted. The autonomous mobile robot is adapted to cut off an unqualified strip segment of the stamped strip having an unqualified terminal by operating the cutting tool, and to weld two cut ends of the cut strip to each other by operating the welding tool.

### CROSS-REFERENCE TO RELATED APPLICATIONS

This application claims priority under 35 U.S.C. § 119 to Chinese Patent Application No. 202010407391.4 filed on May 14, 2020, the whole disclosure of which is incorporated herein by reference.

### FIELD OF THE INVENTION

The present disclosure relates to a stamping strip manufacturing system, and in particular, to a manufacturing system for stamping a terminal strip.

### BACKGROUND

In order to improve the manufacturing efficiency of terminals, a stamping machine is typically used to continuously stamp terminals in a metal strip. The stamped terminals, together with the strip, are then transported to and wound around a recovery reel. However, due to manufacturing variability, there may be some unqualified terminals produced in the stamped strip during the continuous stamping operation. As a result, a strip segment of the strip having the unqualified terminals needs to be cut off from the strip. However, after the unqualified strip segment is cut off, the amount of the strip wound around each recovery reel will be different, which will adversely affect the subsequent utility of the strip. Therefore, after the strip segment is cut off, it is necessary to weld the two cut ends of the strip to each other. However, in the prior art, the cutting and welding of the strip are manually performed, which is not efficient and adversely affects the utilization rate of the stamping machine.

### SUMMARY

According to an embodiment of the present disclosure, a stamping strip manufacturing system includes at least one stamping strip production line. The stamping strip production line comprises a stamping machine forming terminals in a strip by stamping, a supply reel around which the strip to be stamped is wound for supplying the strip to be stamped to the stamping machine, and a recovery reel around which the stamped strip is wound for recovering the stamped strip. The system further includes an autonomous mobile robot on which a cutting tool and a welding tool are mounted. The autonomous mobile robot is adapted to cut off an unqualified strip segment of the stamped strip having an unqualified terminal by operating the cutting tool, and to weld two cut ends of the cut strip to each other by operating the welding tool.

### BRIEF DESCRIPTION OF THE DRAWINGS

The invention will now be described by way of example with reference to the accompanying Figure, of which:

FIG. 1 is a schematic diagram showing a stamping strip manufacturing system according to an exemplary embodiment of the present disclosure.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general technical concept of the present disclosure, a stamping strip manufacturing system is provided, including: at least one stamping strip production line. Each stamping strip production line includes a stamping machine adapted to form terminals in a strip by stamping, a supply reel around which the strip to be stamped is wound and which is configured to supply the strip to be stamped to the stamping machine, and a recovery reel around which the stamped strip is wound and which is configured to recover the stamped strip. The stamping strip manufacturing system further includes an autonomous mobile robot on which a cutting tool and a welding tool are mounted. The autonomous mobile robot is adapted to cut off an unqualified strip segment of the stamped strip having an unqualified terminal from the stamped strip by operating the cutting tool and weld two cut ends of the cut strip to each other by the welding tool.

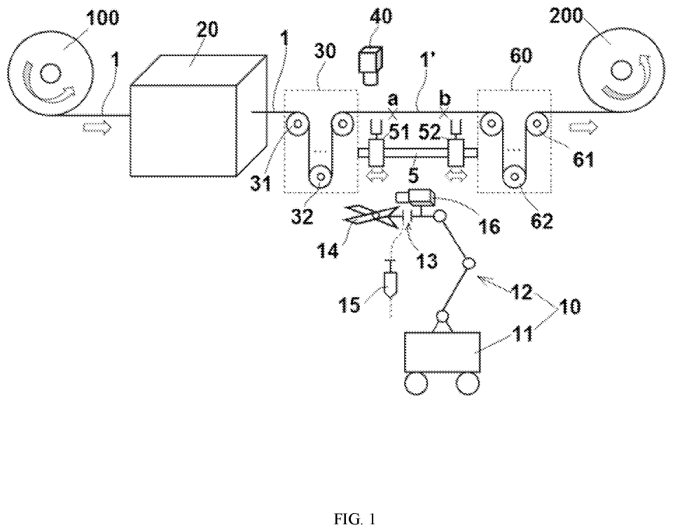

FIG. 1 is a schematic diagram showing a stamping strip manufacturing system according to an exemplary embodiment of the present disclosure.

As shown in FIG. 1, in an embodiment of the present disclosure, the stamping strip manufacturing system includes at least one stamping strip production line. Each stamping strip production line includes a stamping machine 20, a supply reel 100 and a recovery reel 200. The stamping machine 20 is adapted to form terminals in the strip 1 by stamping. The strip 1 to be stamped is wound around the supply reel 100 and the supply reel 100 is configured to supply the strip 1 to be stamped to the stamping machine 100. The stamped strip 1 with the formed terminals is recovered by or wound around the recovery reel 200.

As shown in FIG. 1, in an embodiment of the present disclosure, the stamping strip manufacturing system further includes an autonomous mobile robot 10 on which a cutting tool 14 and a welding tool 15 are mounted, and the autonomous mobile robot 10 is adapted to cut off an unqualified strip segment 1′ of the stamped strip having an unqualified terminal by operating the cutting tool 14 and to weld two cut ends a, b of the cut strip 1 to each other by operating the welding tool 15.

As shown in FIG. 1, in an embodiment of the present disclosure, each stamping strip production line further includes a vision inspection device 40, which is configured to detect whether there is an unqualified terminal in the stamped strip 1 online in real time, so as to determine the unqualified strip segment 1′ to be cut off

As shown in FIG. 1, in an embodiment of the present disclosure, the autonomous mobile robot 10 includes a vehicle-type mobile robot 11 and an arm-type industrial robot 12 carried on the vehicle-type mobile robot 11. In this way, the cutting tool 14 and the welding tool 15 mounted on the autonomous mobile robot 10 can be moved to a predetermined position.

As shown in FIG. 1, in an embodiment of the present disclosure, the arm-type industrial robot 12 has a tool switching plate 13 mounted on its end arm. The cutting tool 14 and the welding tool 15 are mounted on the tool switching plate 13, so as to realize quick switching between the cutting tool 14 and the welding tool 15 by the tool switching plate 13.

As shown in FIG. 1, in an embodiment of the present disclosure, the welding tool 15 may be a laser welding head. However, the present disclosure is not limited to this. For example, the welding tool 15 may also be a soldering iron.

As shown in FIG. 1, in an embodiment of the present disclosure, the autonomous mobile robot 10 further includes a vision device 16 mounted on the end arm of the arm-type industrial robot 12. The vision device 16 is adapted to guide the autonomous mobile robot 10 to perform cutting and welding operations of the strip 1.

As shown in FIG. 1, in an embodiment of the present disclosure, each stamping strip production line further includes a gripping device 5, 51, 52, which is adapted to grip the strip 1 to ensure that the strip 1 remains stationary when the strip 1 is cut or welded by the autonomous mobile robot 10.

As shown in FIG. 1, in an embodiment of the present disclosure, the gripping device 5, 51, 52 includes a slide rail 5 extending in the first direction, and a first gripper 51 and a second gripper 52 which are slidably mounted to the slide rail 5. The first gripper 51 is configured to grip the strip 1 near one cut end a of the two cut ends a, b of the strip 1, and the second gripper 52 is configured to grip the strip 1 near the other cut end b of the two cut ends a, b of the strip 1.

As shown in FIG. 1, in an embodiment of the present disclosure, when the vision inspection device 40 detects an unqualified strip segment 1′, the first gripper 51 and the second gripper 52 grip the strip 1. The autonomous mobile robot 10 cuts off the unqualified strip segment 1′ by operating the cutting tool 14 after the strip 1 is gripped by the first gripper 51 and the second gripper 52.

As shown in FIG. 1, in an embodiment of the present disclosure, after the unqualified strip segment 1′ is cut off, the first gripper 51 and the second gripper 52 are moved towards each other, such that the two cut ends a and b of the strip 1 are aligned and brought into contact with each other. The autonomous mobile robot 10 welds the two cut ends a, b of the strip 1 to each other by operating the welding tool 15 after the two cut ends a, b of the strip 1 are aligned and brought into contact with each other.

As shown in FIG. 1, in an embodiment of the present disclosure, each stamping strip production line further includes a first strip buffering device 30 located between the vision inspection device 40 and the stamping machine 20. The first strip buffering device 30 is adapted to store a predetermined length of a segment of the strip 1, so as to store the strip 1 output from the stamping machine 100 when the strip 1 is gripped by the gripping device 5, 51, 52, ensuring that the stamping machine 20 does not stop when the strip 1 is gripped by the gripping device 5, 51, 52.

As shown in FIG. 1, in an embodiment of the present disclosure, the first strip buffering device 30 includes a pair of first fixed rollers (similar to fixed pulleys) 31 and a movable rollers (similar to a movable pulley) 32 located between the pair of first fixed rollers 31. The strip 1 is supported on the pair of first fixed rollers 31, and the first movable roller 32 is hung on the strip 1 to drive the strip 1 to selectively move downward, so that the predetermined length of the segment of the strip 1 can be stored.

As shown in FIG. 1, in an embodiment of the present disclosure, each stamping strip production line further includes a second strip buffering device 60 located between the gripping device 5, 51, 52 and the recovery reel 200. The second strip buffering device 60 is adapted to selectively store a predetermined length of a segment of the strip 1, so as to continue to supply the strip 1 to the recovery reel 200 when the strip 1 is gripped by the gripping device 5, 51, 52, so as to ensure the recovery reel 200 does not stop when the strip 1 is gripped by the gripping device 5, 51, 52.

As shown in FIG. 1, in an embodiment of the present disclosure, the second strip buffering device 60 includes a pair of second fixed rollers (similar to fixed pulleys) 61 and a movable roller (similar to a movable pulley) 62 located between the pair of second fixed rollers 61. The strip 1 is supported on the pair of second fixed rollers 61, and the second movable rollers 62 are hung on the strip 1 to drive the strip 1 to move downward, so that the predetermined length of the segment of the strip 1 can be stored.

As shown in FIG. 1, in an embodiment of the present disclosure, the supply reel 100, the stamping machine 20, the first strip buffering device 30, the visual inspection device 40, the gripping device 5, 51, 52, the second strip buffering device 60 and the recovery reel 200 of each stamping strip production line are arranged in sequence from upstream to downstream along the conveying direction of the strip 1.

As shown in FIG. 1, in an embodiment of the present disclosure, the stamping strip manufacturing system includes a plurality of stamping strip production lines, and each autonomous mobile robot 10 may automatically move to each of the a plurality of stamping strip production lines to realize the cutting and welding of the strip 1 on the plurality of stamping strip production lines. In this way, there is no need to provide a separate cutting device and welding device for each stamping strip production line, so that the cost can be reduced without affecting the production efficiency.

The production process of the stamping strip will be described below with reference to FIG. 1. With the supply reel 100 continuously supplying the strip 1 to be stamped to the stamping machine 20, the stamping machine 20 continuously stamps the strip 1 to form terminals in the strip 1. The strip 1 passes through the first strip buffering device 30, after which the vision inspection device 40 inspects the stamped strip 1 to detect whether there is an unqualified strip segment 1′ in the stamped strip 1. If the vision inspection device 40 detects an unqualified strip segment 1′, the autonomous mobile robot 10 is informed to move to the unqualified strip segment 1′, while the first gripper 51 and the second gripper 52 grip the two cut ends a and b of the strip 1. It should be noted that the stamping machine 20 will not stop, but rather, the continuously output stamped strip 1 is stored in the first strip buffering device 30. Once gripped, the autonomous mobile robot 10 cuts off the unqualified strip segment 1′ by the cutting toll 14 under the guidance of the vision device 16. The first gripper 51 and the second gripper 52 are then moved towards each other, so that the two cut ends a and b of the strip 1 are aligned and brought into contact with each other. Once in contact, the autonomous mobile robot 10 welds the two cut ends a and b of the strip 1 to each other by the welding toll 15 under the guidance of the vision device 16. Finally, the first gripper 51 and the second gripper 52 are released to release the strip 1 to continue conveying the strip 1.

In the above production process, the second strip buffering device 60 can store a predetermined length of the segment of the strip 1 in advance, so that the second strip buffering device 60 can continue to supply the strip 1 to the recovery reel 200 when the strip 1 is gripped by the gripping device 5, 51, 52. In this way, it can be ensured that the recovery reel 200 does not stop when the strip 1 is gripped by the clamping device 5, 51, 52, thereby improving productivity.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A stamping strip manufacturing system, comprising:
at least one stamping strip production line, each including:
a stamping machine for forming terminals in a strip by stamping;
a supply reel around which the strip to be stamped is wound for supplying the strip to be stamped to the stamping machine; and
a recovery reel around which the stamped strip is wound for recovering the stamped strip; and
an autonomous mobile robot on which a cutting tool and a welding tool are mounted, the autonomous mobile robot adapted to cut off an unqualified strip segment of the stamped strip having an unqualified terminal by operating the cutting tool and to weld two cut ends of the cut strip to each other by operating the welding tool.

2. The stamping strip manufacturing system according to claim 1, wherein each stamping strip production line further comprises a vision inspection device for detecting whether there is an unqualified terminal in the stamped strip and for determining the unqualified strip segment to be cut off.

3. The stamping strip manufacturing system according to claim 2, wherein the autonomous mobile robot comprises a vehicle-type mobile robot and an arm-type industrial robot carried on the vehicle-type mobile robot.

4. The stamping strip manufacturing system according to claim 3, wherein the arm-type industrial robot has a tool switching plate mounted on an end arm thereof, the cutting tool and the welding tool being selectively mounted on the tool switching plate.

5. The stamping strip manufacturing system according to claim 4, wherein the autonomous mobile robot further comprises a vision device mounted on the end arm of the arm-type industrial robot, the vision device guiding the autonomous mobile robot to perform cutting and welding operations of the strip.

6. The stamping strip manufacturing system according to claim 5, wherein each stamping strip production line further comprises a gripping device for selectively gripping the strip to ensure that the strip remains stationary when the strip is cut or welded by the autonomous mobile robot.

7. The stamping strip manufacturing system according to claim 6, wherein the gripping device comprises a slide rail extending in a first direction, and a first gripper and a second gripper which are slidably mounted to the slide rail, the first gripper gripping the strip near one cut end of the two cut ends of the strip, and the second gripper gripping the strip near the other cut end of the two cut ends of the strip.

8. The stamping strip manufacturing system according to claim 7, wherein, when the vision inspection device detects an unqualified strip segment, the first gripper and the second gripper grip the strip, and the autonomous mobile robot cuts off the unqualified strip segment by operating the cutting tool.

9. The stamping strip manufacturing system according to claim 8, wherein, after the unqualified strip segment is cut off, the first gripper and the second gripper are moved towards each other for aligning and bringing the two cut ends of the strip into contact with each other, the autonomous mobile robot welds the two cut ends of the strip to each other by operating the welding tool after the two cut ends of the strip are aligned and brought into contact with each other.

10. The stamping strip manufacturing system according to claim 9, wherein each stamping strip production line further comprises a first strip buffering device located between the vision inspection device and the stamping machine, and the first strip buffering device selectively storing a predetermined length of a segment of the strip output from the stamping machine when the strip is gripped by the gripping device for ensuring that the stamping machine does not stop when the strip is gripped by the gripping device.

11. The stamping strip manufacturing system according to claim 10, wherein the first strip buffering device includes a pair of first fixed rollers and a first movable roller located between the pair of fixed rollers, the strip is supported on the pair of first fixed rollers, and the first movable roller is hung on the strip to drive the strip to move downward for storing the predetermined length of the segment of the strip.

12. The stamping strip manufacturing system according to claim 11, wherein each stamping strip production line further comprises a second strip buffering device located between the gripping device and the recovery reel, the second strip buffering device selectively storing a predetermined length of a segment of the strip so as to continue to supply the strip to the recovery reel when the strip is gripped by the gripping device for ensuring the recovery reel does not stop when the strip is gripped by the gripping device.

13. The stamping strip manufacturing system according to claim 12, wherein the second strip buffering device comprises a pair of second fixed rollers and a movable roller located between the pair of second fixed rollers, the strip is supported on the pair of second fixed rollers, and the second movable roller is hung on the strip to drive the strip to move downward for storing the predetermined length of the segment of the strip.

14. The stamping strip manufacturing system according to claim 13, wherein the supply reel, the stamping machine, the first strip buffering device, the visual inspection device, the gripping device, the second strip buffering device and the recovery reel of each stamping strip production line are arranged in sequence along a conveying direction of the strip.

15. The stamping strip manufacturing system according to claim 1, wherein the stamping strip manufacturing system comprises a plurality of stamping strip production lines, each autonomous mobile robot automatically moving between each of the plurality of stamping strip production lines to realize the cutting and welding of the strip on the plurality of stamping strip production lines.

16. A stamping strip manufacturing system, comprising:
a stamping machine forming terminals in a strip by stamping;
a vision inspection device for detecting an unqualified terminal in the stamped strip; and
an autonomous mobile robot including a cutting tool and a welding tool, the robot adapted to:
cut off an unqualified strip segment of the stamped strip having an unqualified terminal with the cutting tool; and
weld two cut ends of the cut strip to each other with the welding tool.

17. The stamping strip manufacturing system according to claim 16, further comprising a gripping device for selectively gripping the strip to ensure that the strip remains stationary when the strip is cut or welded by the autonomous mobile robot.

18. The stamping strip manufacturing system according to claim 17, wherein the gripping device comprises:
a slide rail extending in a first direction;
a first gripper slidably mounted to the slide rail; and
a second gripper slidably mounted to the slide rail, the first gripper gripping the strip near one cut end of the two cut ends of the strip, and the second gripper gripping the strip near the other cut end of the two cut ends of the strip.

19. The stamping strip manufacturing system according to claim 16, further comprising:
a first strip buffering device located between the vision inspection device and the stamping machine and selectively storing a predetermined length of a segment of the strip;
a second strip buffering device located between a gripping device for gripping the strip and a recovery reel of the system and selectively storing a predetermined length of a segment of the strip.

20. The stamping strip manufacturing system according to claim 19, wherein:
the first strip buffering device includes a pair of first fixed rollers and a first movable roller located between the pair of fixed rollers, the strip is supported on the pair of first fixed rollers, and the first movable roller is hung on the strip to drive the strip to selectively move downward for storing the predetermined length of the segment; and
the second strip buffering device includes a pair of second fixed rollers and a movable roller located between the pair of second fixed rollers, the strip is supported on the pair of second fixed rollers, and the second movable roller are hung on the strip to drive the strip to selectively move downward for storing the predetermined length of the segment.
